(19) United States
(12) Patent Application Publication
(10) Pub. No.: US 2026/0129201 A1
(43) Pub. Date: May 7, 2026

(54) METHODS OF PERFORMING ENTROPY CODING SCHEME FOR SIGNAL ENHANCEMENT FILTER, DECODER, AND STORAGE MEDIUM

(71) Applicant: GUANGDONG OPPO MOBILE TELECOMMUNICATIONS CORP., LTD., Dongguan (CN)

(72) Inventors: Tim CLASSEN, Dongguan (CN); Mathias WIEN, Dongguan (CN)

(73) Assignee: GUANGDONG OPPO MOBILE TELECOMMUNICATIONS CORP., LTD., Dongguan (CN)

(21) Appl. No.: 19/435,193

(22) Filed: Dec. 29, 2025

Related U.S. Application Data
(63) Continuation of application No. PCT/CN2023/105596, filed on Jul. 3, 2023.

(51) Int. Cl. H04N 19/13; H04N 19/147; H04N 19/172; H04N 19/91

(52) U.S. Cl. CPC H04N 19/13; H04N 19/147; H04N 19/172; H04N 19/91

(57) ABSTRACT

A method of performing an entropy decoding scheme for a signal enhancement filter is provided. The method includes: bitstream is parsed and entropy decoding of filter parameters is performed; filter parameter decoding is performed; and filter parameter inverse quantization is performed.

### CROSS REFERENCE TO RELATED APPLICATION

This is a continuation of International Application No. PCT/CN2023/105596 filed on Jul. 3, 2023, the disclosure of which is hereby incorporated by reference in its entirety.

### TECHNICAL FIELD

The present application relates to the field of computer vision, in particular to the topic of video processing and video coding, more particularly to methods of performing an entropy coding scheme for a signal enhancement filter, a decoder, and a computer-readable medium.

### BACKGROUND

Current video coding schemes such as H.265/HEVC (High Efficiency Video Coding) and H.266/VVC (Versatile Video Coding) support spatial scalability of the coded video stream. Adaptively changing the resolution of the coded video during coding is known from VVC as reference picture resampling (RPR) or adaptive resolution change (ARC). Moreover, multiple-resolution coding and multi-layer coding allows for a scalable resolution of the coded video. For that reason, the spatial resolution at which a video is coded may change adaptively and no longer needs to be equivalent to the output or input resolution of the video. The advantages of this additional flexibility are that coding a lower resolution video requires a lower bitrate and may reduce computational complexity at the cost of losing high frequency information in the downsampling step.

Coding a video at lower resolution than its original resolution requires a downsampling and an upsampling step in the signal processing chain. In the downsampling step, an anti-aliasing filter is applied to prevent artifacts caused by high frequency components in the image. The upsampling process applies interpolation filters to reconstruct the intensity values at fractional sample positions.

In RPR, the resolution of the coded video stream may change adaptively. Consequently, the encoder may code parts of the video stream at lower resolution. RPR is applied in the inter-prediction every time that a picture uses a reference picture of different resolution than the current picture in inter frame prediction. In this step, a resampling operation needs to be applied such that the referenced picture block is mapped to the same spatial resolution as the current picture.

In multi-layer coding, the video is coded at different resolution layers. In a first step, the video is coded at the lowest resolution layer. To generate the video stream of the next layer, the video is upsampled and, potentially, a residual is coded and further processing steps are applied. This process may be applied multiple times based on the number of layers.

Finding an optimal high-resolution representation from the low-resolution picture is an important part of the above-mentioned coding schemes. A common method is to apply a set of multi-phase Finite Impulse Response (FIR)-interpolation filters. While those filters do provide a good approximation of the high-resolution image content, they cannot recover information that was lost in the downsampling process and suffer from limitations of the linear filtering operation. Consequently, upsampled images are usually blurred. Therefore, an image sharpening operation could increase the picture quality. However, linear high-pass filters frequently cause artifacts such as overshoot and ringing. Moreover, the distortions caused by the down- and upsampling depend on the image content and the coding quality of the video (influenced by the Quantization Parameter (QP) value).

Applying an adaptive filter with local weighting is an approach to deal with those problems. The local weighting can be applied to smoothly increase or decrease the strength of the filter at local regions. One could think of a weighting that increases the filter strength at edge regions but decreasing it at regions where ringing would typically occur. With such a setup, an optimized filter could amplify high frequency components without causing significant ringing. This is especially helpful in an image upsampling scenario where the amplification of high frequency components is required to sharpen blurred edges. Adaptive filters are required to deal with the different characteristics of coding artifacts and video content.

The presented approach requires some side information to be sent. Those are some flags, filter coefficients, region partitioning information and mode parameters. For video coding applications it is substantial to minimize the required transmission rate. This means that the additional number of bits should be minimized. To reduce the number of bits, a coefficient coding scheme is proposed which exploits redundancies in the information which needs to be transmitted.

### BRIEF DESCRIPTION OF THE DRAWINGS

Embodiments will now be described, by way of example only, with reference to the accompanying drawings, in which:

FIG. 1A shows a flowchart of the operations of a method of performing an entropy coding scheme, performed by an encoder, for a signal enhancement filter according to embodiments of the invention;

FIG. 1B shows a flowchart of the operations of optimizing parameter encoding based on estimated rate distortion costs according to embodiments of the invention;

FIG. 2 shows four filter coding modes which aim at predicting filter coefficients and/or filter parameters according to embodiments of the invention;

FIG. 3A shows using separate coding modes according to embodiments of the invention;

FIG. 3B shows using the same coding mode for the whole filter according to embodiments of the invention;

FIG. 4 shows an example for filter prediction for intra filter coding mode according to embodiments of the invention;

FIG. 5 shows filter prediction for inter filter coding mode according to embodiments of the invention;

FIG. 6 shows filter selection for copy filter coding mode according to embodiments of the invention;

FIG. 7 shows a schematic illustration of a decoder according to various embodiments of the invention; and

FIG. 8 shows a schematic illustration of an encoder according to various embodiments of the invention.

### DETAILED DESCRIPTION

Technical solutions in the embodiments of the present application will be described clearly and completely below with reference to the accompanying drawings.

These technical solutions may be applied to a H.265/HEVC or H.266/VVC video coding system, particularly in the performance of RPR, ARC, multiple-resolution coding, and multi-layer coding. However, it is to be understood that these technical solutions may applied in any other video coding system that involves upsampling. Furthermore, while these principles are primarily illustrated with reference to video processing, they are also applicable to other data forms, including image processing or even audio processing.

A “video” in the embodiments refers to one or more pictures. In other words, a video can include one picture or a plurality of pictures. A picture may also be referred to as an “image”.

An “encoder” is a device capable of encoding data into a bitstream, while a “decoder” is a device capable of decoding the bitstream in order to obtain the encoded data, or an approximation of the encoded data. A “bitstream” comprises a sequence of bits.

“Intra-prediction” and “inter-prediction” are two prediction operations that can be used within the HEVC and VVC frameworks for a decoder to process a received bitstream in order to obtain the original signal. In the embodiments, “original signal” or “original video” is used to refer to the data prior to encoding at the encoder 20. A reference sample in the embodiments may refer to spatially and/or temporally spaced picture data used for the prediction of a picture (or region of a picture). Intra and inter-prediction operations are also used at the encoder to make rate-distortion decisions.

In more detail, intra-prediction involves the prediction of data spatially within a single picture, without a reference to other (temporally spaced) pictures. In other words, data for a first region of a picture is used in the prediction of the data for another region of the same picture, but there is no dependence on another temporally spaced picture. In this context, the data for the first region of the picture is considered a “reference sample”.

Inter-prediction involves the prediction of data between a plurality of temporally-spaced pictures. In other words, data for a first region of a first picture is used in the prediction of data for a second region of a second picture. The first and second region may or may not be spatially separated from one another. In this context, the data for the first region of the first picture is considered a “reference sample”. It is further noted that inter-prediction may sometimes use multiple reference regions from different pictures at once, i.e. for a single prediction operation.

A “residual” in the embodiments may refer to value obtained based on an original value of a region of a picture and a prediction value of the region of the picture (e.g. the difference between the original value and the predicted value).

A “block” in the embodiments may refer to a portion of a picture. For example, a picture may be portioned into two or more blocks. However, this only an example. If a picture is not partitioned, then a “block” can refer to the entire picture.

A “signal enhancement filter” may refer to a filter that acts to enhance a signal, particularly an upsampled signal. In general, in the described embodiments, the signal enhancement filter is a filter configured to reduce edge blurring (i.e. to sharpen a picture block). However, embodiments are not limited to this and the signal enhancement filter can instead be configured to provide alternative or additional signal enhancements in other embodiments, such as removing blocking artifacts and/or ringing artifacts.

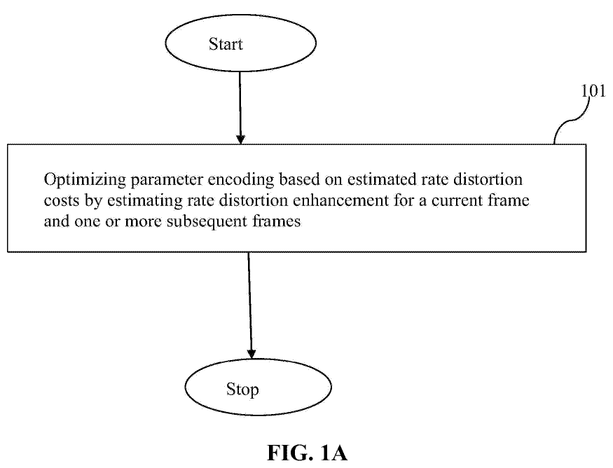

FIG. 1A shows a flowchart of the operations of performing an entropy coding scheme for a signal enhancement filter.

The flowchart of FIG. 1A shows at step 101 that a parameter encoding is optimized based on estimated rate distortion costs by estimating rate distortion enhancement for a current frame and one or more subsequent frames. Before continuing with the description of the figures, a few items of the invention are explained in more detail.

The proposed invention provides a method to encode parameters for an adaptive reference picture upsampling. Thereby, the demands of a transmission in an adaption parameter set and characteristics of side information are considered to allow for an efficient coding scheme.

In some of the embodiments, the coding scheme is rate distortion optimized which means that the coding scheme has effects on the distortion of the downstream task (picture upsampling). It should be noted that there are two kinds of distortion. The first one is the distortion in the downstream task, i.e. the distortion after the enhancement filter is applied to some coded signal. The second distortion is the distortion of the coded parameters.

Embodiments of the invention rely on two main components/steps, namely
a) a prediction scheme for filter parameters; and
b) encoding of filter coefficients by an entropy encoding with low complexity.

In some of the embodiments, the prediction scheme uses inter-dependencies between different parameters. Thereby, parameters may be predicted from previously decoded parameters of the same parameter set such that the difference between the predicted and ground truth coefficient is transmitted. This makes sense if entropy of the residual is smaller than entropy of the parameters. Moreover, parameters from previous frames may be reused without coding a residual. Lastly, there is also the option to modify the residual or the transmitted parameters in order to reduce coding costs which has effects on the distortion in the downstream task. Therefore, the modifications need to be rate distortion optimized.

An upsampling process is required in video coding applications like RPR and multi-layer/multi-resolution coding. Those methods usually apply an interpolation filter to generate the subpixel values of the upsampling filter. Exemplary, the method according to embodiments of the invention is applied directly after the interpolation filter and before any other processing steps. The purpose is to reduce distortions caused by the low-resolution video coding. Those are the loss of high-frequency information and distortions caused by the video coding. In this scenario, e.g. the default upsampling filter would be used for the initial resolution change.

The method according to embodiments of the invention is applied independently afterwards and does not modify the existing resampling process but instead adds a-potentially optional-enhancement step. Embodiments of the invention specify a possible implementation of a parameter encoding scheme for the aforementioned upsampling enhancement scheme.

Generally, an efficient encoding of any additional data that is sent is important to increase the efficiency of the overall method. Gains may only be achieved if the rate-distortion performance is increased by the method. That means that the required bitrate for achieving a certain distortion level d is smaller if the method is applied compared to not applying the method.

$${d}_{method} ( r ) < {d}_{baseline} ( r )$$

Thereby, the rate for coding a bitstream using the method according to embodiments of the invention is defined in the following equation.

$$r = {r}_{encoder} + {r}_{method}$$

In the following, the main interest lies on the parameters r_{method} which are directly used by the method and the distortion d_{method}. All other parameters are not directly affected by the proposed encoding. However, indirect effects are possible due to the change of content. Computing those indirect effects is difficult and would require doing the encoding itself. Since this is very demanding in terms of computation time and program complexity, it is proposed to model those effects. For this, it is distinguished between direct and indirect effects of the method. The direct effects are understood as the reduction of distortion in the current picture by applying the method according to embodiments of the invention. Indirect effects are two-fold. The first indirect effect is that the rate-control may decide to encode a subsequent frame at a slightly lower rate due to the increased number of bits in the current frame. The second indirect effect only comes into play if the current picture is referenced by some upsampled picture. In this case, the inter-prediction is performed on the enhanced picture content. It is assumed that, in most cases, if the quality of the source picture is better, the prediction would also be better which would lead to a smaller residual. Consequently, the quality increase might positively affect other pictures. In order to do an optimal rate-distortion decision, both effects need to be taken into account.

The direct effects can be estimated by measuring the distortion compared to the ground-truth after the enhancement filter is applied and estimating the additional rate required to signal the adaption parameter set. To reduce computational complexity, a simplified measure or approximation of the distortion is used in some of the embodiments.

The indirect effects are much more difficult to estimate in a precise way. Therefore, it is proposed to use a simplified model.

In some of the embodiment, this model calculates the RD-gains for other frames when applying the proposed method to the current frame. In some of the embodiments, the RD-enhancement is calculated and summed up for all frames, which have the current frame in the reference picture list. Those frames can be easily inferred from the encoder configuration. The model takes into account the quality of the frame before the filtering is applied and the quality of the frame after the filter is applied, the rate and the coding configurations (e.g. QP, reference picture lists (RPLs), QPs of all pictures in RPL, picture size of pictures in RPL). With that, the RD-enhancement of this picture is computed. A simple model for the RD-enhancement calculation for a P-frame or B-frame n is shown below.

$$Δ {RD}_{P} ( n ) = \frac{1}{2} {\sum }_{i ∈ RPL 0 ( n )} w ( i , p ) \tilde{Δ {RD}_{P}} ( i )$$

$$Δ {RD}_{B} ( n ) = \frac{1}{2} [ {\sum }_{i ∈ RPL 0 ( n )} w ( i , {p}_{0} ) \tilde{Δ {RD}_{B}} ( i ) + {\sum }_{i ∈ RPL 1 ( n )} w ( i , {p}_{1} ) \tilde{Δ {RD}_{B}} ( i ) ]$$

The Δ [symbol] (i) is zero if i is unequal to the current picture and equal to the RD-enhancement if i is equal to the current picture. The function w(i,p) returns a scalar weighting factor. The weighting factor depends on the coding parameter p and the current index i. For example, a higher weighting would be given for frames that are closer to the framen, i.e. if |i−n| is small. The reason for that is, that the frame usually has more similar content if it is closer to the predicted frame in temporal dimension. Moreover, the horizontal and vertical rescaling factor and the QP of the frame are taken into account. For example, it is assumed that frames with low QP which are encoded at high resolution would be used more frequently than frames that have a higher QP or a lower resolution as their quality is typically lower. That is, having distortions in the reference frame would lead to a larger error in the prediction signal, if it is assumed that the current frame and the reference frame have similar content and that the errors in the reference frame are uncorrelated to the temporal changes between the two frames.

As a result of this formula, an RD-offset is obtained for each frame that references the current frame. By adding up those RD-offsets, the overall RD-improvement with regards to reference pictures is obtained. It should be noted that this scheme might also take into account that a reference picture in the RPL might reference the current frame. To account for that, the previous formula might be applied recursively. However, this is left out here for simplicity. Consequently, the following equation is obtained to calculate the overall RD gain if ΔRD_{B/P}(n) is defined to be the RD-difference of applying the filter to the current frame.

$$Δ {RD}_{all} ( n ) = {\sum }_{i} Δ {RD}_{B / P} ( i )$$

With this formula, the ΔRDₐₗₗ(n) can be optimized to be minimal. Several methods are proposed to decrease the signaling costs for the enhancement filter. This improves the overall RD-performance and may also make this type of filtering suitable for a larger variety of content.

There are two different kinds of data which need to be signaled and optimized. The first kind of data are flag and mode decision parameters. Those parameters are compressed in a lossless mode. The reason for that is that such parameters severely affect the performance of e.g., on-/off decisions in the filter. Those parameters are, for example: luma-/chroma on/off-flags, filter shape parameter (separable/non-separable and overall shape of the filter), quantization parameters (step-size, clipping, etc.), weighting map type, coding mode.

On the other side, there are filter coefficients and (conceptually continuous) weighting map function parameters which are quantized or modified before encoding and transmission in order to have a finite number of well compressible code words. Those parameters include the filter coefficients of luma and chroma filters and the weighting map parameters. In the following, the quantization and coding scheme will be described.

The following section contains a detailed description of parameters which can be used in such a setup. This includes all, potentially optional parameters which might be used to adapt and signal the behavior of the proposed filter. First of all, there are luma and chroma flags. Those flags indicate, whether the filter is applied to the luma and/or chroma component. If one of those flags is false, no parameters are coded for this channel. Each of the luma and chroma filters has a weighting map function (which might have parameters itself) and a filter. The weighting map is specified by a parametric function which is calculated from the coded video. The parameters of the weighting map function depend on the type of weighting map and are signaled depending on the type of weighting map function. The set of parametric weighting map functions is pre-defined. The chosen weighting map function may either be signaled or chosen depending on the content. In addition to the weighting map, the parameters of the filter are transmitted. Those are the filter shape, possibly quantization parameters and the filter coefficients. Moreover, encoding information may be signaled as well. This could be information on the behavior of the quantization process, the parameter prediction or the entropy coding. This information may be transmitted for luma and chroma filter separately or for both filters at the same time. Lastly, information on the location of application of each filter may be signaled. That means that a filter might only be applied to a part of the picture. Thereby, the part to which each filter is applied might be signaled in the bitstream or inferred from the video content and/or coding information. Note that there is the option to encode multiple filters with different parameters. Moreover, two filters might be applied to the same spatial location of a frame.

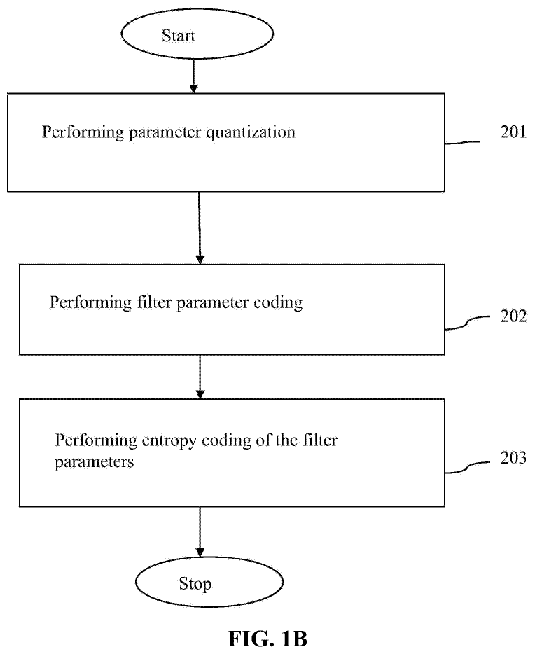

Returning now to FIG. 1B which shows a flowchart of the operations of optimizing parameter encoding based on estimated rate distortion costs. At 201, parameter quantization is performed. At 202, filter parameter coding is performed using four different filter coding modes which will be explained by taking reference to FIG. 2. Finally, at 203, entropy coding of the filter parameters is performed.

Taking a closer look at the step of parameter quantization 201, it becomes clear that for the transmission of parameters and calculations in video coding, filter parameters need to be mapped to integer values. In some of the embodiments, this is performed by clipping floating-point values to some range [tₘᵢₙ, tₘₐₓ]. Afterwards, the values are scaled by some scaling factor s_{scale} and rounded to the nearest integer. In some of the embodiments, the overall process is described by the following equation:

$${a}_{quantized} = round ( min ( max ( a , {t}_{min} ) , {t}_{max} ) {s}_{scale} )$$

Thereby, the number of quantization intervals is given as n_{bins}=(tₘₐₓ−tₘᵢₙ)s_{scale}+1 assuming that tₘₐₓ, tₘᵢₙ and s_{scale} are integer valued.

In some of the embodiments an applicable bit-depth for parameter quantization is 12 bit. With that, the number of bits for the quantized numbers would be 12 with n_{bins}=2¹². However, any number of bins in the range of 10 to 14 was found to work in a test scenario. On the one side, a higher scaling factor results in a lower quantization error and thus, in a more precise representation of a number. On the other side, there are more bins which typically results in higher coding costs. The upper and lower threshold should be chosen in a way that the clipping error does not affect the performance significantly. However, the smaller the range is set, the less bins are required to achieve the same quantization error which reduces coding costs. Finding good quantization parameters is important for the final performance. For example, clipping filter coefficients too early might significantly affect the performance. Note that this is only an example of a quantization scheme which could be used in this place. A rate-distortion optimized quantization might be used as well.

Moreover, in some of the embodiments, a different quantization step size is applied depending on the filter-coefficient. For example, using a smaller quantization for the mean of the filter might make sense as the errors caused by an offset in the low frequency coefficients of a filter are usually larger than the errors caused by higher frequency coefficients.

In some of the embodiments, the parameters of the quantization scheme are signaled in the parameter set or fixed for all encoding setups depending on the characteristics of the data. If there is a high variation in terms of content, especially with regards to the dynamics of the coded signal and residual, an adaptive quantization scheme might show benefits. However, if there is less variation, it might make sense to estimate optimal parameters in advance in order to reduce signaling costs.

FIG. 2 shows filter parameter coding and discloses four filter coding modes, namely a new filter coding mode 401, a new filter intra coding mode 402, a new filter inter coding mode 403 and a copy filter coding mode 404. Each of these modes aims at the prediction of filter coefficients and/or filter parameters.

In some of the embodiments, the filter parameters comprise at least one of filter coefficients, coding parameters, region partitioning information (if multiple filters are applied), weighting map parameters or other side information. In some of the embodiments, filter coefficients cause the largest coding costs. That is why most effort is spent on reducing the coding costs of filter coefficients. Each mode is signaled by a mode flag. All other parameters are derived based on the mode flag. In some of the embodiments, the mode parameter is signaled for each filter or for each of the Y, U, V channels or separately for luma and chroma channels. This means that in some of the embodiments there is an encoding scheme that signals the luma and chroma flags first and then signals the mode parameter afterwards for each channel separately in case that the filter is activated for this channel. In other embodiments, the coding mode is signaled first.

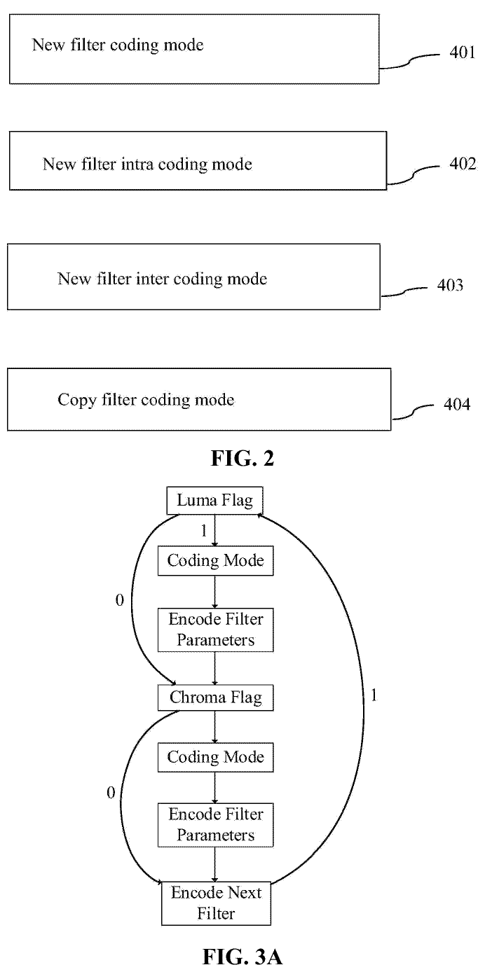

FIG. 3A shows an encoding scheme that signals the luma and chroma flags first and then signals the mode parameter for each channel separately in case that the filter is activated for this channel. FIG. 3B shows an encoding scheme in which the coding mode is signaled first. The embodiment shown in FIG. 3B has the advantage of lower coding costs since the coding mode needs to be signaled only once and luma/chroma flags are also derived based on the coding mode.

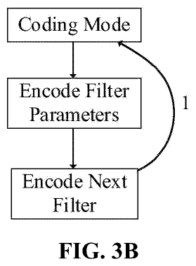

Before discussing the new filter intra coding mode 402 with reference to FIG. 4, the new filter coding mode 401 will be discussed.

In some of the embodiments, the new filter coding mode 401 is supposed to be selected if the filter is not well predictable by any of the other coding modes. In such a case, the filter coefficients are encoded in their quantized representation. This means that no prediction is applied to the filter coefficients besides that, in some of the embodiments, one coefficient is replaced by the mean of the filter. It is proposed to use this prediction for the coefficient with the highest entropy because this prediction works reliably due to the characteristics of the coding scheme. In mathematical terms: All of the predictions assume that there are certain statistical dependencies with respect to the filter coefficients. If those statistical dependencies hold true with high probability, then the prediction and ground truth are similar in most cases. However, if those assumptions do not hold true, it may be cheaper to skip prediction entirely.

With reference to FIG. 4, the new filter intra coding mode will now be discussed. The new filter intra coding mode makes use of dependencies between filter coefficients of the same filter. Assuming that a series of n filter coefficients [a₁, . . . aₙ] need to be encoded. Without restriction of generality, the ordering of the en-/decoding may be set to the numerical order of the indices. That means, that filter coefficient a₁ is encoded first and the filter coefficents aᵢ are encoded in increasing order. Thereby, the filter coefficient at may use filter coefficients a₁, . . . , aᵢ₋₁ for prediction. Moreover, there may be some dependency on the current filter coefficient aᵢ. For each coefficient, some, possibly learned, context/prediction model may be used. Thereby, the model does not need to be equivalent for every coefficient.

For example, one may employ a very simple model, where filter coefficient a₁ is encoded without modifications and all subsequent coefficients are encoded as the difference to the previous coefficient cᵢ=aᵢ−aᵢ₋₁. The last filter coefficient is encoded as the mean over all filter coefficients cₙ=Σᵢaᵢ. It can be assumed that the residual/coding error is usually close to a zero-mean distribution. Therefore, the sum over all filter coefficients would also be close to zero in most cases. Therefore, the entropy of the probability distribution of the sum would be smaller than the entropy of the probability distribution of the n-th coefficient in most cases, which is why such an encoding might make sense. This exemplary implementation is shown in FIG. 4.

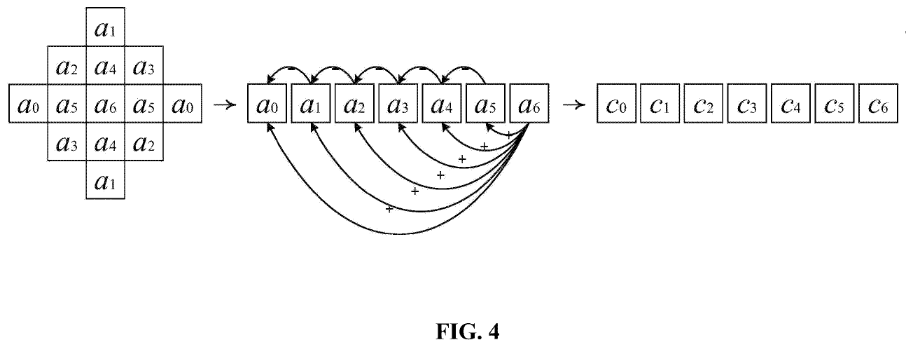

FIG. 5 shows the new filter inter coding mode 403 in more detail which performs prediction of the next filter coefficients based on a previous filter. Thereby, the filter coefficients a_{t,i} are predicted by filter coefficients at time step t+j, with j being some offset in temporal domain. Moreover, multiple filters are used for a combined prediction. A simple example of an implementation for a new filter inter mode would be to have a POC-adaptive reference set of filters. For example, one might have all filters that correspond to filters in the reference picture set in the reference filter set. Another option might be to always store the, temporally, closest n filters. The current filter might be predicted by signaling the index of the predicting filter in the reference picture list. Then, the current filter could, for example, be directly predicted by the selected reference filter. Then, the residual between the current and reference filter is encoded. This makes sense if it can be assumed that the filter coefficients remain similar for subsequent frames. This is an assumption that relies on temporal correlations of the encoded video. If the error signal of the video has similar statistics for frames that are close in terms of temporal/coding order, then the filters might be similar as well. Consequently, there is a small residual signal. This can be exploited by entropy coding of the residual which reduces the costs for each symbol. FIG. 5 shows how such a prediction scheme might work. Thereby, there is a set of k filters which can be used for prediction each filter may be used to do a prediction of the filter a. Then, the residual between the prediction and residual is computed. Afterwards, the coding costs for each reference filter are estimated and the filter with the lowest coding costs is chosen. Note that there is the option to apply some transformation to the residual. A notable transformation would be to replace one filter coefficient by the sum of the filter coefficients. Moreover, some kind of intra-prediction might be applied as well after the residual calculation. Lastly, there is also the option to do a combined prediction which makes use of multiple filters.

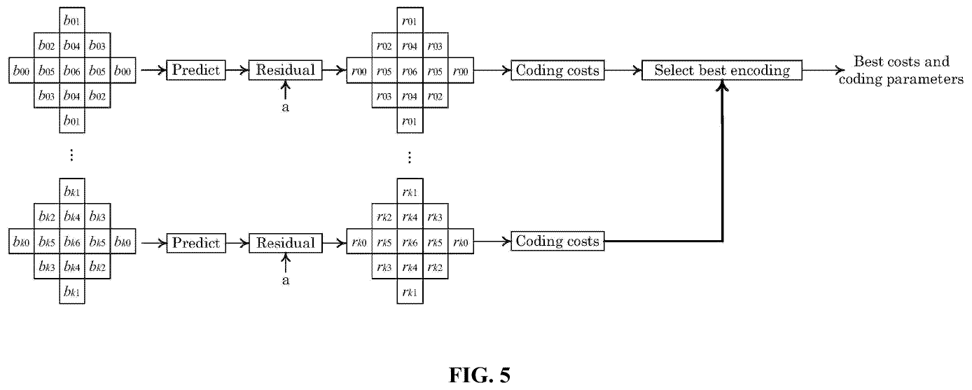

FIG. 6 shows the filter copy mode which copies all filter coefficients and, potentially other filter parameters which makes this mode cheap at the cost of a reduced flexibility. In some of the embodiments, this mode is used in order to apply the same filter to another frame which may be suitable if the encoded video and residual of two or more frames is very similar. In such cases, a filter which was optimized for some previous frame may still improve the current frame. In most cases, there may be a reduced quality enhancement. However, due to the decreased coding costs, this might be suitable in terms of RD-costs. FIG. 6 shows a schematic implementation of the optimization of the filter copy mode. Thereby, a set of filters which were signaled previously may be in the reference filter list. The reference filter list contains a subset of the available filter bi which were previously decoded.

The “New Filter Inter” and “Filter Copy” mode make use of filter parameters from previous filters to predict the current filter. The filter from which the current filter is predicted is indicated by an index. Filters in the reference list may be filters which have been transmitted for some previously coded frame. Other options are pre-calculated filters and filters which are inferred from the video content. In general, there might be many filters available from which the prediction could be done after some frames. As the number of bits required for coding the filter index increases with the number of indices, which need to be represented, we propose to only select a subset of filters for the reference list. The selected filters may depend on the previously signaled parameters and other factor like, for example, the selected weighting map, luma and chroma filter shapes, etc.

Finally, the step of performing entropy coding of the filter parameters will be analysed in more detail. The parameters for the enhancement filter are signaled in the adaption parameter set (APS). This is a high-level parameter set which means that not all entropy coding tools are available. For example, there is usually no arithmetic coding used at this level. Therefore, the following methods will also be restricted to entropy methods which are or could be applied in such a parameter set.

The following section outlines an exemplary implementation of the entropy coding. Note that this is only an example and there are many modifications which might be suitable as well some possible adjustments will be discussed in the following description as well.

The main goal of the entropy coding step is to reduce the average coding costs for encoding the symbols. This is, in general, done by assigning longer code words to less frequent symbols and shorter code words to more frequent code words. The binary entropy is a measure for the minimal average number of bits that would be required to encode a symbol of some given probability distribution. In the given application, the residual of the predicted filter coefficients is encoded. In this scenario, a code that can encode any possible symbol/filter coefficient as efficiently as possible is required. The efficiency of a code can be measured by the Kullback-Leibler divergence which gives us the average increase of bits per symbol if we choose to encode the symbols by a certain code instead of an entropy optimal code. Note that we cannot use an entropy optimal code due to complexity reasons. This means that an entropy optimal encoding or an arithmetic encoding might be too complex to be applied at the given level. However, it is still a theoretical option and might be used if the design paradigm would allow for that. At the current point in time, simple structured codes are used at the APS level. More specifically, exponential Golomb-codes are frequently used to encode symbols in the APS. This code can be used with signed and unsigned integers and is able to encode every possible integer number. This code assumes that the probability of a symbol decreases exponentially with its magnitude. This makes sense, for the encoding of residual signals because the residual signal is small, if the underlying assumptions of the prediction mode holds. Therefore, there should be very many small values and much less frequent large values in terms of magnitude. However, there are also other options like Golomb-Rice codes and k-th order exponential Golomb codes which would also be suitable for a structured encoding of filter coefficients. We propose to use a structured code (e.g. the above mentioned codes) in case that an low-complexity implementation is required. Moreover, we propose to either estimate the optimal hyper-parameters from a test set or to signal the entropy coding hyper-parameters. An example that would work well to encode the data after the prediction process is to use the exponential Golomb-code. For our application, this code assumes a probability of low magnitude values that is slightly too high. This makes it not RD-optimal. However, this is also very dependent on the type of data and the encoding which is why this cannot be seen as a general statement.

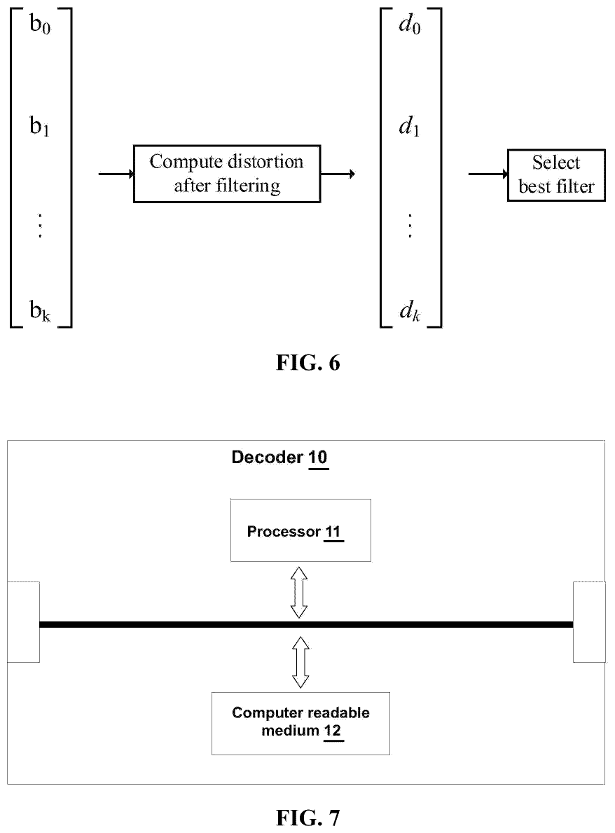

FIG. 7 shows a schematic illustration of a decoder 10 according to an embodiment. Specifically, FIG. 7 shows a schematic illustration of a decoder 10 configured to perform any of the decoder methods discussed herein. Such detailed descriptions thereof are omitted here for brevity.

As shown in FIG. 7, the decoder 10 comprises a processor 11 and a computer readable medium 12. The processor 11 and the computer readable medium 12 may be connected via a bus system. The computer readable medium is configured to store programs, instructions or codes. The processor 11 is configured to execute the programs, the instructions or the codes in the computer readable medium 12 so as to complete the operations in the decoder method embodiments herein.

Hence, in embodiments, the computer readable medium 12 is configured to store a computer program capable of being run in the processor 11, and the processor 11 is configured to run the computer program to perform steps in any of the decoder methods discussed herein.

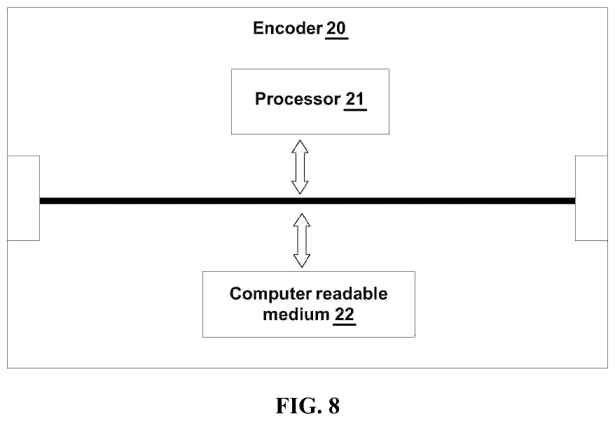

FIG. 8 shows a schematic illustration of an encoder 20 according to an embodiment. Specifically, FIG. 8 shows a schematic illustration of an encoder 20 configured to perform any of the encoder methods discussed herein. Such detailed descriptions thereof are omitted here for brevity.

As shown in FIG. 8, the encoder 20 comprises a processor 21 and a computer readable medium 22. The processor 21 and the computer readable medium 22 may be connected via a bus system. The computer readable medium is configured to store programs, instructions or codes. The processor 21 is configured to execute the programs, the instructions or the codes in the computer readable medium 22 so as to complete the operations in the decoder method embodiments herein.

Hence, in embodiments, the computer readable medium 22 is configured to store a computer program capable of being run in the processor 21, and the processor 21 is configured to run the computer program to perform steps in any of the decoder methods discussed herein.

Embodiments of the invention can also provide a computer-readable medium having computer-executable instructions to cause one or more processors of a computing device to carry out the method of any of the embodiments of the invention.

Examples of computer-readable media include both volatile and non-volatile media, removable and non-removable media, and include, but are not limited to: solid state memories; removable disks; hard disk drives; magnetic media; and optical disks. In general, the computer-readable media include any type of medium suitable for storing, encoding, or carrying a series of instructions executable by one or more computers to perform any one or more of the processes and features described herein.

Embodiments of the present application provide a method, a decoder, an encoder, and a computer-readable medium for signal enhancement filtering for reference picture resampling and/or picture upscaling that overcome problems associated with conventional arrangements.

According to a first aspect, a computer-implemented method of performing an entropy coding scheme for a signal enhancement filter, performed by an encoder, is provided. The method includes optimizing parameter encoding based on estimated rate distortion costs by estimating rate distortion enhancement for a current frame and one or more subsequent frames.

In some of the embodiments, the signal enhancement filter is an edge-guided signal enhancement filter.

In some of the embodiments, estimating rate distortion enhancement comprises calculating the rate distortion enhancement and summing it up for the one or more subsequent frames which have the current frame in their reference picture list.

In some of the embodiments, the method further comprises
performing parameter quantization; performing filter parameter coding; and
performing entropy coding on the filter parameters.

In some of the embodiments, parameter quantization comprises mapping continuous values to a finite set of code words.

In some of the embodiments, filter parameter coding is performed using a new filter coding mode, a new filter intra coding mode, a new filter inter coding mode and a copy filter coding mode, wherein each of these modes aims at a prediction of filter coefficients and/or filter parameters.

In some of the embodiments, the new filter coding mode is selected if the filter is not well predictable by any of the other coding modes.

In some of the embodiments, the new filter intra coding mode predicts filter coefficients based on other filter coefficients of the same filter and makes use of dependencies between filter coefficients of the same filter.

In some of the embodiment, the new filter inter coding mode performs prediction of filter coefficients of a next filter based on filter coefficients of a previous filter.

In some of the embodiments, the copy filter coding mode copies all filter coefficients and is used to apply the same filter to another frame.

In some of the embodiments, the new filter inter coding mode and the copy filter coding mode make use of filter parameters from previous filters to predict a current filter, wherein the filter from which the current filter is predicted is indicated by an index and filters in a reference list are filters which have been transmitted for some previously coded frame.

In some of the embodiments, the filter parameters are signaled in an adaption parameter set and a systematic code is used to perform the entropy encoding of the filter parameters.

In some of the embodiments, simple structured codes are used to perform the entropy encoding of the filter parameters.

In some of the embodiments, exponential Golomb-codes, Golomb-Rice codes or k-th order exponential Golomb codes are used to perform the entropy encoding of the filter parameters.

In some of the embodiments, separate chroma and luma filters are used.

In some of the embodiments, on-/off-flags for the luma and chroma filters are used.

In some of the embodiments, the method is used for an adaptive reference picture upsampling scheme.

According to a second aspect, a computer-readable medium is provided which comprises computer executable instructions stored thereon which when executed by a computing device cause the computing device to perform any of the methods discussed in relation to the first aspect.

According to a third aspect, an encoder is provided. The encoder comprises one or more processors; and a computer-readable medium comprising computer executable instructions stored thereon which when executed by the one or more processors cause the one or more processors to perform any of the methods discussed in relation to the first aspect.

It will be appreciated that the functionality of each of the components discussed can be combined in a number of ways other than those discussed in the foregoing description. For example, in some embodiments, the functionality of more than one of the discussed devices can be incorporated into a single device. In other embodiments, the functionality of at least one of the devices discussed can be split into a plurality of separate (or distributed) devices.

Conditional language such as “may”, is generally used to indicate that features/steps are used in a particular embodiment, but that alternative embodiments may include alternative features, or omit such features altogether.

Furthermore, the method steps are not limited to the particular sequences described, and it will be appreciated that these can be combined in any other appropriate sequences. In some embodiments, this may result in some method steps being performed in parallel. In addition, in some embodiments, particular method steps may also be omitted altogether.

While certain embodiments have been discussed, it will be appreciated that these are used to exemplify the overall teaching of the present invention, and that various modifications can be made without departing from the scope of the invention. The scope of the invention is to be construed in accordance with the appended claims and any equivalents thereof.

Many further variations and modifications will suggest themselves to those versed in the art upon making reference to the foregoing illustrative embodiments, which are given by way of example only, and which are not intended to limit the scope of the invention, that being determined by the appended claims.

1. A method of performing an entropy coding scheme for a signal enhancement filter, performed by an encoder, the method comprising:
optimizing parameter encoding based on estimated rate distortion costs by estimating rate distortion enhancement for a current frame and one or more subsequent frames.

2. The method of claim 1, wherein estimating rate distortion enhancement comprises calculating the rate distortion enhancement and summing it up for the one or more subsequent frames which have the current frame in their reference picture list.

3. The method of claim 1, further comprising
performing filter parameter quantization;
performing filter parameter coding; and
performing entropy coding of the filter parameters.

4. A method of performing an entropy decoding scheme for a signal enhancement filter, performed by a decoder, the method comprising:
parsing bitstream and performing entropy decoding of filter parameters;
performing filter parameter decoding; and
performing filter parameter inverse quantization.

5. The method of claim 4, wherein filter parameter decoding is performed using
a new filter decoding mode,
a new filter intra decoding mode,
a new filter inter decoding mode or
a copy filter decoding mode, wherein each of these modes aims at a prediction of filter coefficients and/or filter parameters.

6. The method of claim 4, wherein filter parameters comprise at least one of filter coefficients, decoding parameters, region partitioning information, weighting map parameters or other side information.

7. The method of claim 5, wherein the new filter decoding mode is selected if the filter is not well predictable by any of the other decoding modes.

8. The method of claim 5, wherein the new filter intra decoding mode predicts filter coefficients based on other filter coefficients of the same filter and makes use of dependencies between filter coefficients of the same filter.

9. The method of claim 5, wherein the new filter inter decoding mode performs prediction of filter coefficients of a next filter based on filter coefficients of a previous filter.

10. The method of claim 5, wherein the copy filter coding mode copies all filter coefficients and is used to apply the same filter to another frame.

11. The method of claim 5, wherein the new filter inter decoding mode and the copy filter decoding mode make use of filter parameters from previous filters to predict a current filter, wherein the filter from which the current filter is predicted is indicated by an index and filters in a reference list are filters which have been transmitted for some previously coded frame.

12. The method of claim 4, wherein the filter parameters are determined from an adaption parameter set and a systematic code is used to perform the entropy decoding of the filter parameters.

13. The method of claim 12, wherein simple structured codes are used to perform the entropy decoding of the filter parameters.

14. The method of claim 12, wherein exponential Golomb-codes, Golomb-Rice codes or k-th order exponential Golomb codes are used to perform the entropy decoding on the filter parameters.

15. The method of claim 12, wherein separate chroma and luma filters are used.

16. The method of claim 15, wherein on-/off-flags for the luma and chroma filters are used.

17. The method of claim 4, wherein the method is used for an adaptive reference picture upsampling scheme.

18. The method of claim 4, wherein the method is used after an interpolation filter and before any other processing steps.

19. A non-transitory computer-readable medium, having a computer program and a bitstream stored thereon, wherein the computer program, when executed by a processor, enables the processor to perform the method of claim 1 to generate the bitstream.

20. A decoder, comprising
one or more processors; and
a computer-readable medium comprising computer executable instructions stored thereon which when executed by the one or more processors cause the one or more processors to perform operations of:
parsing bitstream and performing entropy decoding of filter parameters;
performing filter parameter decoding; and
performing filter parameter inverse quantization.
